(19) United States
(12) Patent Application Publication
(10) Pub. No.: US 2018/0008504 A1
(43) Pub. Date: Jan. 11, 2018

(54) FOOT MASSAGE PAD

(71) Applicant: Osiris C. Terry, Honolulu, HI (US)

(72) Inventor: Osiris C. Terry, Honolulu, HI (US)

(21) Appl. No.: 15/204,569

(22) Filed: Jul. 7, 2016

(51) Int. Cl. A61H 7/00

(52) U.S. Cl. CPC A61H 7/002; A61H 2201/0107; A61H 2205/12

(57) ABSTRACT

The foot massage pad of the invention includes a substrate which form a base for the foot massage pad. The substrate can be made of any material that is sufficiently rigid to maintain its shape when used as described below. For example, the substrate might be plastic, wood, metal, stone, rubber, or any other suitable material. In one preferred embodiment, the substrate is composed of neoprene rubber or similar material. The substrate has a top surface and a bottom surface. The bottom surface of the substrate is designed to engage frictionally with the surface below it to restrict movement of the substrate. The substrate may be placed on the floor, for example, and the bottom surface will cause additional friction to maintain the substrate's position when force is applied to it. In some embodiments, the material composing the substrate has a high coefficient of friction, though a texture may be applied to bottom surface to increase friction.

### BRIEF DESCRIPTION OF THE FIGURES

FIGS. 1A and 1B are a schematic representation depicting a perspective view of a preferred embodiment of the invention.

FIGS. 2A, 2B, 2C, 2D, and 2E are schematic representations depicting perspective views of preferred embodiments of the invention.

FIG. 3 is a schematic representation depicting a perspective view of a preferred embodiment of the invention.

FIG. 4 is a schematic representation depicting a perspective view of a preferred embodiment of the invention.

### DESCRIPTION OF THE PREFERRED EMBODIMENTS

As shown in the figures, the foot massage pad 100 comprises a top surface 101 having at least two raised edges 102 along its perimeter edge, a bottom surface 103, and massage inserts 201, 401.

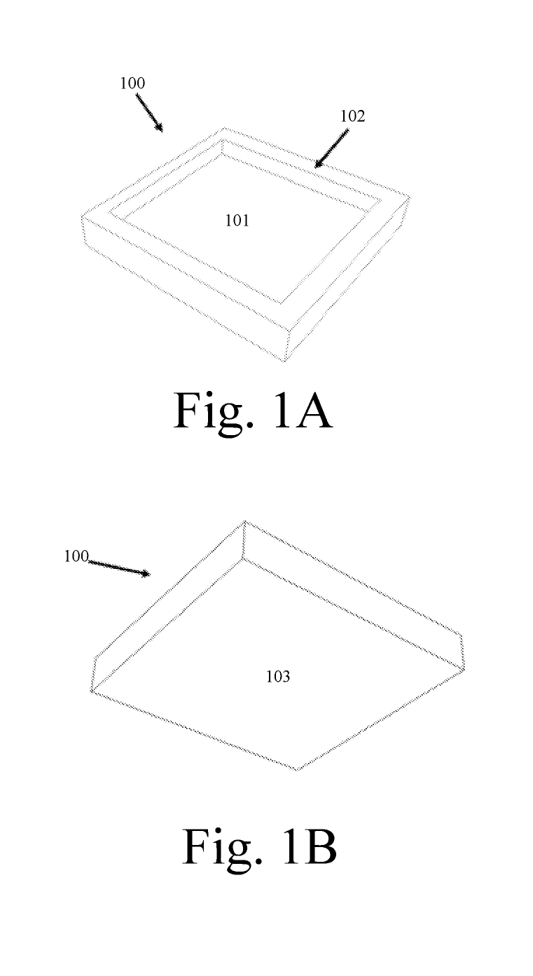

One preferred embodiment of the invention is shown in FIGS. 1A and 1B. This embodiment includes a substrate which form a base for the foot massage pad 100. The substrate can be made of any material that is sufficiently rigid to maintain its shape when used as described below. For example, the substrate might be plastic, wood, metal, stone, rubber, or any other suitable material. In one preferred embodiment, the substrate is composed of neoprene rubber or similar material. The substrate has a top surface 101 and a bottom surface 103. The bottom surface 103 of the substrate is designed to engage frictionally with the surface below it to restrict movement of the substrate. The substrate may be placed on the floor, for example, and the bottom surface 103 will cause additional friction to maintain the substrate's position when force is applied to it. In some embodiments, the material composing the substrate has a high coefficient of friction, though a texture may be applied to bottom surface 103 to increase friction.

The top surface 101 of the substrate may optionally be designed similar to bottom surface 103 in order to engage better with massage inserts 201 and 401. On at least two sides of top surface 101, raised edges 102 are disposed. The raised edges 102 may be rigid or semi-rigid.

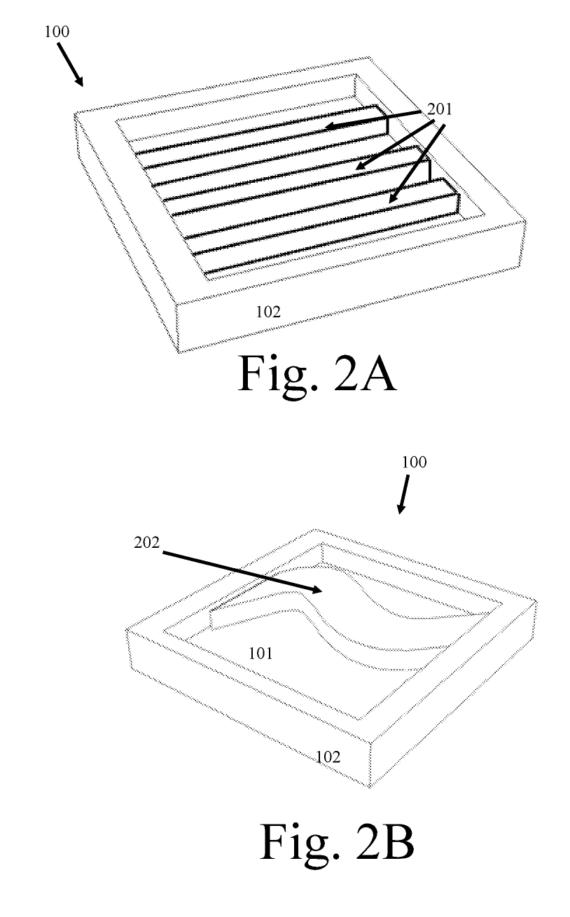

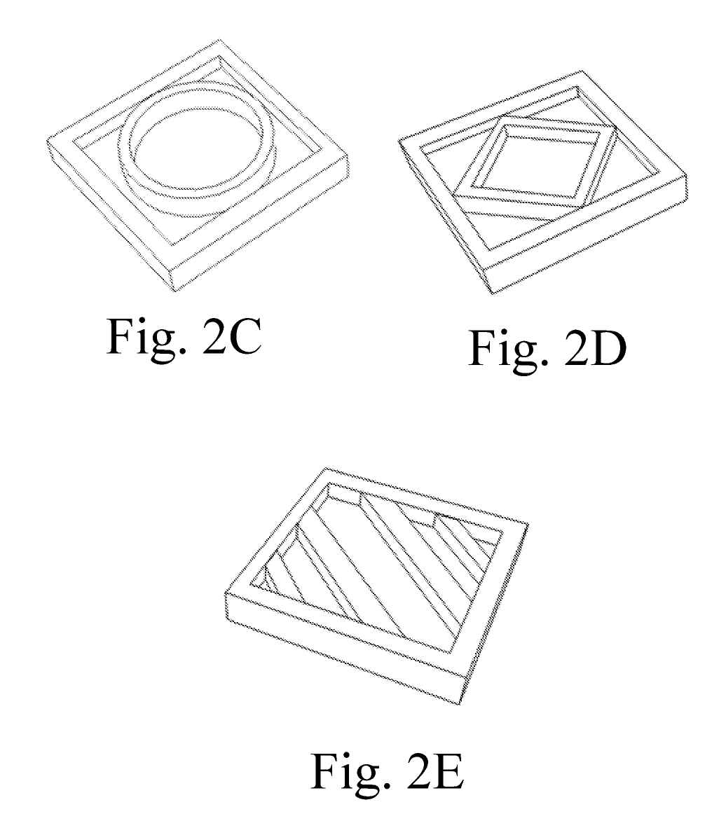

Massage inserts, which are textured or shaped members, may be placed on the top surface 101 and engaged with raised edges 102 to prevent their movement. In practice, a user would place the foot massage pad 100 on the floor or another flat surface and use the massage insert to massage his or her feet by rubbing or pressing the foot against or along the massage insert. FIGS. 2A and 2B show embodiments of the foot massage pad 100 having a top surface 101, raised edges 102, a bottom surface 103 (not shown), and massage inserts 201. FIG. 2A depicts the foot massage pad 100 having three massage inserts 201 engaged with the raised edges. FIG. 2B depicts the foot massage pad 100 having a single curved massage insert 201. In both FIGS. 2A and 2B, the massage inserts 201 are engaged at their ends with the raised edges 102. The massage insert 201 may have a length sufficient to engage both ends with raised edges 102. The massage insert 201, of the raised edges 102, may have some flexibility to allow massage inserts 201 to be removed and inserted when the user chooses while remaining motionless when in place. In other embodiments, the raised edges 102 have enough flexibility to curve inwards towards the top surface 101 to engage the massage inserts 201 by pinching them against the top surface 102. In these embodiments, the user may select a desired massage insert 201 from a selection and insert it into the foot massage pad 100 for use.

The massage inserts may have any of a number of different ridged or raised patterns to provide different textures to provide different sensations to the user during use. Certain embodiments might include patterns such as a zig-zag set of rigid lines, chevron patterns, a diamond pattern (either a single diamond or multiple concentric diamonds), an oval (either a single oval or multiple concentric ovals). For example, FIG. 2C shows an oval pattern, FIG. 2D shows a diamond pattern, and FIG. 2E shows a diagonal line pattern.

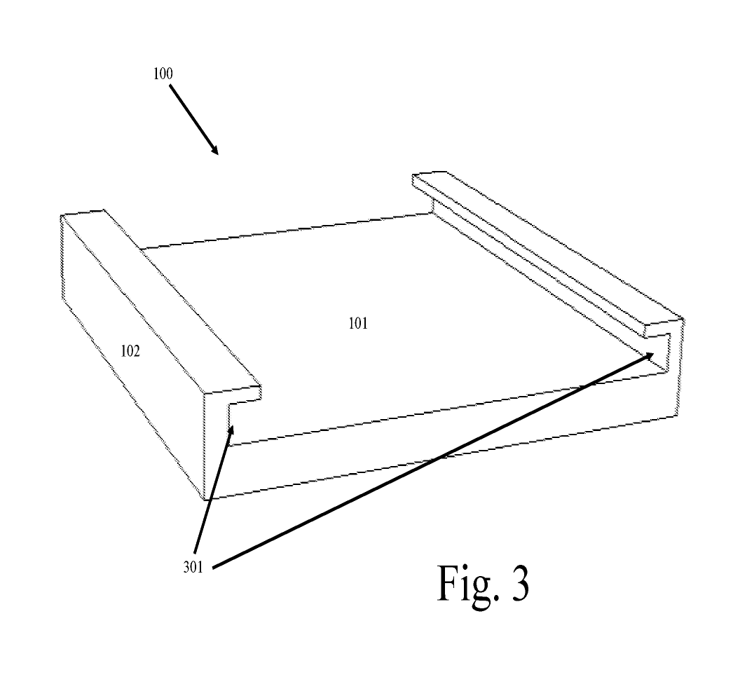

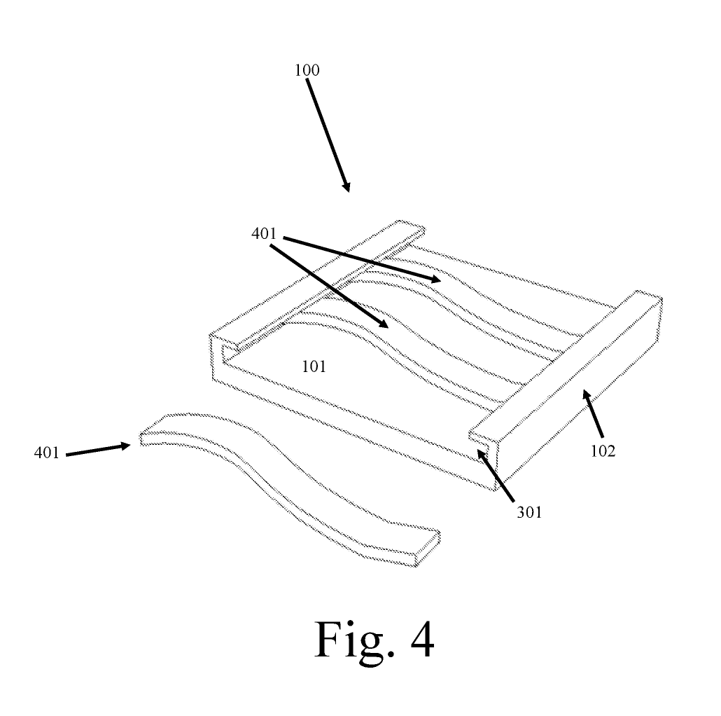

FIGS. 3 and 4 depict another embodiment of the invention in which the raised edges 102 include a recess 301 running parallel to the top surface 101. The massage inserts 401 may be inserted into the recess 301 and slid into place as desired.

The massage inserts 201 and 401 may be of any shape, size, or texture, and the present invention allows the user to select the appropriate inserts for their needs at the time. For a light massage, a user may choose inserts having a small curvature and minimal texture. For a heavier massage, a user may choose an insert with a texture resembling pebbles or large bumps. The surface of the massage inserts 201 and 401 may be covered with an appropriate surface, such as a molded plastic that provides a pleasing feeling to the user's feet.

When using certain substrates, patterns may be molded directly into the substrate. Such patterns may be on the bottom surface of the substrate to increase frictional engagement with the supporting surface (such as the floor), or alternatively on the top surface to further engage with massage inserts or to provide additional textured surfaces for the user's use. If the patterns cannot be molded directly into the substrate, or if molding is impractical or unwanted, the patterns may be created on a second substrate which is then bonded to the appropriate surface of the first substrate.

The above descriptions are only examples and are not intended to be limitations of the invention.

I claim:

1. A foot massage pad comprising:
a substrate having a bottom surface, a top surface, and at least two raised edges positioned on the perimeter of the top surface;
at least one massage insert;
wherein the massage insert is configured to engage the at least two raised edges to restrict movement of the massage insert along at least one axis.

2. The foot massage pad of claim 1, wherein the bottom surface of the substrate has a texture configured to increase friction when engaged with another surface.

3. The foot massage pad of claim 1, wherein the one massage insert has a textured surface.

4. The foot massage pad of claim 1, wherein the massage insert engages the at least two raised edges frictionally.

5. The foot massage pad of claim 1, wherein raised edges are curved towards the top surface of the substrate and wherein the two raised edges and top surface of the substrate engage the massage insert by pinching.

6. The foot massage pad of claim 1, wherein the two raised edges comprise a recess disposed parallel to the top surface and wherein the massage insert is configured to engage the raised edges inside the recess.

7. The foot massage pad of claim 1, wherein the massage insert comprises a convex top surface.
